(19) United States
(12) Patent Application Publication
(10) Pub. No.: US 2010/0096194 A1
(43) Pub. Date: Apr. 22, 2010

(54) Wheelchair for stairs and obstacles

(76) Inventor: Lazo Starcevic, (US)

Correspondence Address: ERIC HANSCOM, 7395 PORTAGE WAY, CARLSBAD, CA, 92011, US

(21) Appl. No.: 12/443,693

(22) PCT Filed: Sep. 28, 2007
(86) PCT No.: PCT/HR07/00029

§ 371 Date: Mar. 31, 2009

(30) Foreign Application Priority Data
Oct. 2, 2006 (HR) P2006032A

(51) Int. Cl. B62D 55/04; B60K 1/00

(52) U.S. Cl. 180/8.2; 180/65.31

(57) ABSTRACT

The wheelchair for stairs and obstacles consists of a power supply assembly (FIG. 1, item 8), i.e., internal combustion motor serving as battery charger, a battery, a drive wheel-belt pulley (FIGS. 1 and 4, item 1), a tyre (or a full-rubber ring) of a greater diameter FIGS. 1 and 4, item 1a), indented drive belts of a smaller diameter FIGS. 2, 4 and 5, item 26), a foldable front wheel-pulley belt pendulum-support (FIG. 1, item 2, FIG. 3), pendulum elevating assembly (FIG. 1, items 4, 5 and 6), caster wheel elevator (FIG. 2, items 23, 24 and 25), legrest elevator (FIG. 2, item 18a), seat moving assembly to shift the centre of gravity in stair-climbing (FIG. 1 and 2, items 9, 9a, 9b and 9c), enabling the user to move comfortably indoors and on a flat surface with a partly elevated caterpillar drive pendulum (FIG. 1), to negotiate depressions and protrusions (FIG. 6), thresholds, curbs, etc. (FIG. 2), to move upstairs (FIG. 7) and downstairs (FIG. 8), thus having an unlimited radius of movement. The user can negotiate all the mentioned obstacles riding and looking forward, keeping the seat slant comfortable and safe.

### AREA OF APPLICATION

This Invention belongs to the group of accessories for self-transportation of disabled persons, i.e., stair-climbing and obstacle-mounting wheelchair consisting of the following assemblies: the internal combustion motor supplying the battery charger (in the other version only the battery); combined drive wheels each tyre-fitted with two caterpillar belts. The caterpillar drive system is foldable, so the wheelchair can also be used indoors, or the system can be elevated and lowered for climbing stairs and negotiating obstacles. Installed in the wheelchair are: the elevating caster wheel assembly, the seat forward-backward moving assembly, the elevating legrest assembly for climbing upstairs. According to the International Patent Classification (IPC), the Invention can be classified under A 61 G 5.

### TECHNICAL PROBLEM

Disabled persons still encounter the problems of reaching various premises, including those of vital importance: clinics, hospitals, public institutions, schools, etc., etc., let alone all kinds of everyday obstacles restricting their freedom of movement, often including the impossibility of getting out of their building or apartment if only because of a stair or two. A special problem is the inability to go outdoors or make a trip to nature, a need the gratification of which is one of the basic rights of human beings, whether physically handicapped or not.

### PRIOR ART

The existing solutions deal with the said problems of disabled persons only partially. Wheelchair-transporting vehicles are usable only for loading on special vehicles (suitable for collective use), whereas many patented solutions for individual use have largely remained at the level of drawings (never materialised due to their impracticality and excessive robustness). The fault of materialised wheelchair solutions, offered by manufacturers, is that they climb stars backwards, preventing the user to follow the course of movement. Even when crossing over curbs the user must turn the wheelchair counter to the direction of movement and then, after mounting the obstacle, turn it again. Riding backwards is certainly an unpleasant experience, accompanied by certain anxiety. In order to ensure that in the caterpillar drive on stairs the wheelchair does not overturn backwards, the caterpillar must be long enough, but then the caterpillar is inconvenient for indoor use, as well as too long, which makes the existing caterpillar solutions not safe enough, because their cannot reconcile the two seemingly opposed features. In other words, no solution is offered yet which would combine a wheelchair for indoor movement with (easily) foldable caterpillar drive and a stair-climbing wheelchair with an unlimited movement radius.

### THE ESSENCE OF THE INVENTION

The primary purpose of the Invention is to solve the problem of the limited freedom of movement faced by disabled persons, to make those public places accessible to them which they cannot reach independently and thus enable them to satisfy their need for going out into the open without fear to get stuck at every small obstacle, even more, to reach the farthest destinations without fearing to discharge the drive battery thanks to a combustion motor installed in the wheelchair.

Secondary goals are multiple, beginning with the satisfaction of disabled persons at seeing the obstacles surmountable, which alleviates the feeling of helplessness and thus contributes to the maintenance of their mental health. Further advantages include reduced costs of adapting the places which disabled persons must visit but are unable to (this Invention makes such adaptations unnecessary), so finances can be redirected for dealing with other problems encountered by disabled persons. Both of these goals are important in terms of human rights considerations.

The wheelchair for stairs and obstacles solves virtually all the above outlined problems owing to its design consisting of the following:

A power drive assembly, a combustion motor serving as battery charger (in the other version, the battery only) is mounted on a firm light metal tube frame to supply the electric drive motors with power for outdoor movement, keeping the battery charged at all times. Further assemblies are: electric drive motors (with reduction gear) to propel the wheelchair (separately for the left and right drive wheel); and electric drive motor (with reduction gear) for elevating and lowering the caterpillar assembly (in the other version, separate motors for the left and right sides); an electric drive motor (with reduction gear) for elevating and lowering the caster wheels; and an electric drive motor (with reduction gear) for forward-backward movement of the seat (with backrest). All the mentioned assemblies are controlled via suitable electric joysticks.

The main feature of the wheelchair is its drive wheel design, which makes it a wheel and a belt pulley in one. The tyre (or a full-rubber tyre) is mounted on a suitable external radial groove, and along the groove two grooves of smaller diameter are lathed for indented rubber belts (or, in the other version, a wider slot for the indented endless rubber strip). The belt (or strip) teeth are required to engage the rim (of a curb, a threshold or another obstacle). The belt (or strip) teeth do not touch the ground, because the belts rotate in a smaller diameter, which allows a comfortable ride without shaking that would otherwise accompany a ride on rough belt teeth. The other front wheel has no slot for the tyre (rubber ring), only slots for the indented belts (or a single slot for the indented endless rubber strip). While moving on a flat surface (unless over a ditch or a depression on the street) it revolves in the air, held above ground by a pendulum. The pendulum is so fixed on the axis of rotation of the drive wheel that the belt tension remains uniform in any position of the pendulum. By means of an elevating electric motor assembly the pendulum can be kept at various angles depending on the configuration of the ground. On the front pendulum segment an elevating legrest assembly is mounted, which, when elevated, leans on the pertaining overhang on the legrest and lifts the legrest to a height which will not obstruct climbing upstairs.

The left and right pendulums are kept parallel by guides attached to the wheelchair frame. The cogwheel segment, attached to the pendulum, glides in these guides. The cogwheel segment is coupled to the electric motor drive gear which effects the pendulum inclination. The front pendulum end (the segment of the pendulum on which the front wheel is attached) is so designed that it can turn around a special shaft, which makes it possible to remove the drive belts and to drastically shorten the wheelchair, so that it can become an electric wheelchair suitable for indoor movement. The segment position is fixed by a lock.

On the front of the wheelchair the elevating caster wheel assembly is mounted, consisting of an electric motor with reduction gear and a bolt fixed to the wheelchair frame, which, coupled to a nut on the caster wheel housing, elevates or lowers the caster wheels to the required height. The caster wheel housing guides are mounted sideways on the wheelchair frame to enable the caster wheel housing to turn and change the direction of movement.

On the rear of the wheelchair the seat moving assembly with backrest is mounted, consisting of an electric motor with reduction gear and a bolt (the so-called actuator) fixed to the seat frame which is coupled to the support of linear ball bearings on which the seat rests and which enable it to move.

Mounted on the armrests and on rear handgrips for the assistant to the disabled person are pertaining control switches or the so-called parallel controls.

All the mentioned assemblies are self-braking to respond to the need of retention in an existing position, a feature required due to a great transmission ratio of their reduction gears. All the mentioned assemblies are controllable by means of electric joysticks-variators and allow the installation of sensors in the more sophisticated version of the wheelchair.

### DRAWINGS

The accompanying drawings are a constituent part of the description of the Invention and should illustrate its basic principle

FIG. 1 Wheelchair for stairs and obstacles, folded for indoor use;

FIG. 2 Wheelchair for stairs and obstacles, prepared for outdoor ride on a flat surface

FIG. 3 Pendulum front segment (front wheel support) in out-of-function and in-function wheel positions, the lock also shown;

FIG. 4 Drive wheel, cross-section;

FIG. 5 Front wheel, cross-section;

FIG. 6 Wheelchair for stairs and obstacles crossing over depressions en route;

FIG. 7 Wheelchair for stairs and obstacles climbing stairs, seat with backrest shifted forward

FIG. 8 Wheelchair for stairs and obstacles moving downstairs

### DETAILED DESCRIPTION OF TWO WAYS IN WHICH THE INVENTION CAN BE REALISED

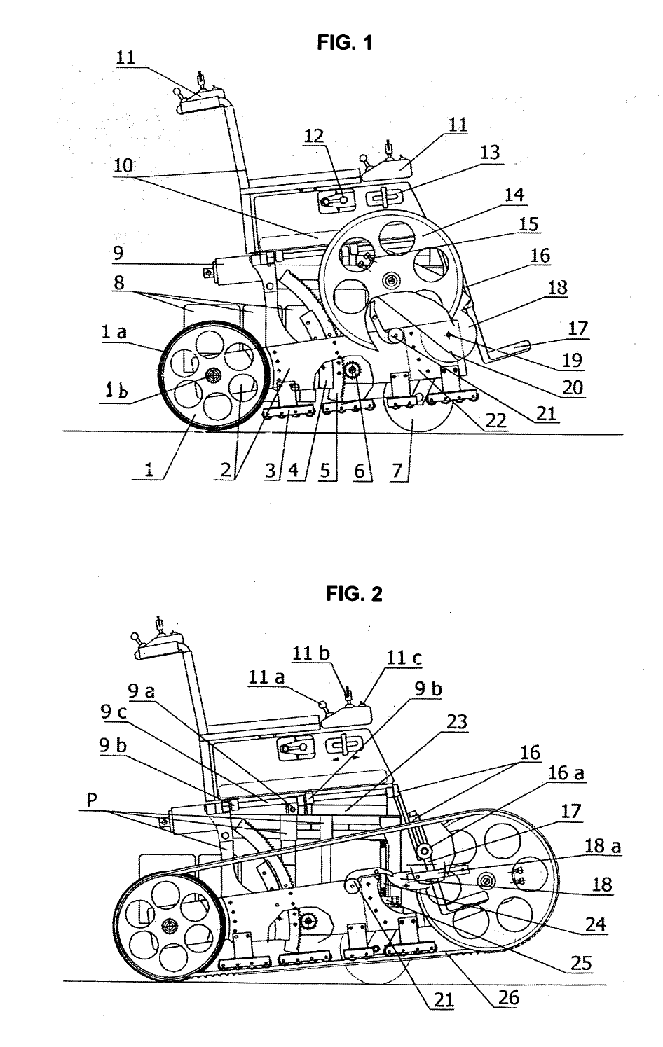

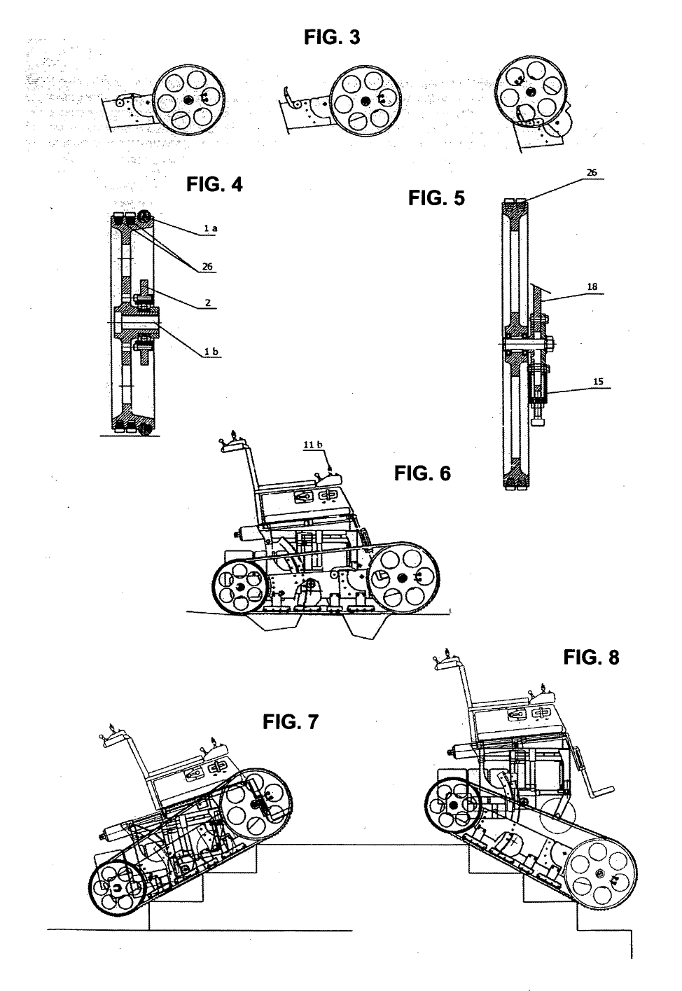

Wheelchair for stairs and obstacles, shown in FIGS. 1 and 2, is propelled by the electric power source (FIG. 1, item 8) installed in the wheelchair's base frame (FIG. 2, item P). Movement takes place on two drive wheels (FIG. 1, item 1) and two front caster wheels (FIG. 1, item 7). On the drive wheel a tyre or a full-rubber ring (FIGS. 1 and 4, item 1) is placed and indented belts tightened (FIGS. 2 and 4, item 26) which are also supported by the front wheel (FIGS. 1 and 5, item 14) supported for its part by the pendulum segment (FIGS. 1 and 2, item 18). The caster wheels are designed for movement on a flat surface or indoors. From the wheelchair folded for indoor use (FIG. 1), with the front wheel folded upwards (FIG. 1, item 14), the teeth and belts are removed. The front wheel (FIG. 1, item 14) rests on the pendulum segment (FIG. 1, item 18) which is an element of the pendulum (FIG. 1, item 2) and can be rotated around the shaft (FIG. 1, item 19 and 3) for the removal of the indented belts (FIG. 2, item 26). The pendulum segment ((FIG. 1, item 18) is fixed in the operating position by a lock (FIG. 2, item 21). Fixed on the pendulum (FIG. 1, item 2) is a cogwheel segment (FIG. 1, item 5) which is coupled to the cogwheel (FIG. 1, item 6) of the pendulum elevator, by means of which the pendulum can be elevated or lowered rotating around the drive wheel axis (FIGS. 1 and 4, item 1b). The pendulum parallelism is secured by the cogwheel segment guide (FIG. 1, item 4) mounted on the wheelchair base frame (FIG. 2, item P). Fixed on the pendulum are belt supports (FIG. 1, item 3) which prevent the bending of the belts on obstacle rims. On the pendulum segment (FIG. 1, item 18) there is an elevator (FIG. 2, item 18a) of the legrest (FIGS. 1 and 2, item 17), which, while elevating the pendulum, meets the overhang roll (FIG. 2, item 16a) in the legrest housing (FIG. 2, item 16) and lifts the legrest above the stair rim. When the pendulum sinks, the legrest automatically returns to its original position. The caster wheel elevator is actuated in the ascending movement (FIG. 6) and then the caster wheels are out of function, lifted so as not to obstruct the stair rims. They are lowered for movement outdoors on a flat surface and indoors (FIGS. 1 and 2). The seats with backrest are moved by activating the seat assembly (FIG. 1, item 9) by means of an electric joystick (FIG. 1, item 13). The seat assembly (FIG. 1, item 9) is connected by a coupling ((FIG. 2, item 9a) to linear bearings (FIG. 2, item 9b) which via the guides (FIG. 2, item 9c) carry the seat forward or backward. Thereby the joint man-wheelchair centre of gravity is shifted over the rim before the drive wheel (FIG. 1, item 1) separates from the base (FIG. 6). This solution reduces the need for a much longer caterpillar which would obstruct (or even prevent) indoor movement. For lowering the caterpillar below the horizontal level for movement down stairs, the joystick (FIG. 1, item 12) is operated to actuate the cogwheel (FIG. 1, item 6) of the caterpillar lowering assembly. The cogwheel is coupled to the cogwheel segment (FIG. 1, item 5) attached to the pendulum (FIG. 1, item 2) and with its rotation lowers the pendulum (FIG. 1, item 2) by a required angle for the seat to remain in the same position as in flat-ground ride (FIG. 8). At the end of the descent the process is reverse, the pendulum is elevated to a required height.

### WAYS OF USING THE INVENTION

The described wheelchair for stairs and obstacles can be made by using the enclosed workshop drawings prepared in a proper ratio to real sizes, with special account taken of the spatial arrangement of individual assemblies plotted according to their real dimensions (for example, the enclosed wheel details). This Invention can be applied by adding the described assemblies to an already existing wheelchair by adapting its dimensions, whereas the details can be made from various functionally suitable materials without abandoning the essence of the Invention and its basic features (such as the alcohol-using internal combustion motor or the lithium ion battery). In this way a wheelchair for stairs and obstacles will be obtained which with its major improvements in many respects surpasses the existing solutions.

1. The wheelchair for stairs and obstacles, consisting of a base on which the following assemblies are mounted: the internal combustion motor serving as battery charger (or, in the other version, battery only); a pair of drive wheels which are at the same time belt pulleys carrying tyres (or, in the other version, full-rubber rings) and indented belts (in the other version, indented endless strips) for climbing stairs and negotiating obstacles; a pair of front wheels-belt pulleys which over the indented belts (in the other version, indented endless strips) are coupled to the drive wheels, thus making with them a caterpillar drive pendulum, designed to be foldable; front caster wheels which can be lifted and lowered; the elevating caterpillar drive assembly; the seat moving assembly; and the elevating legrest assembly; characterized in that the drive wheel is so designed that the indented belts rotate without touching the ground, in order to make flat-ground ride comfortable, that the caterpillar drive is foldable, that stair climbing and obstacle negotiation occurs in forward direction, that the legrests are lifted automatically with the elevation of the pendulum and that in stair-climbing the backrest-fitted seat is moved mechanically to shift the centre of gravity.

2. The wheelchair for stairs and obstacles, incorporating a drive wheel of novel design, characterized in that it carries a radial slot for the tyre (or a full-rubber ring) and slots of a smaller diameter for indented rubber belts (or for an indented endless strip), which (slots) are so designed that the rubber belt (strip) teeth do not touch the ground in movement so as to make a flat-ground ride tolerable.

3. The wheelchair for stairs and obstacles, incorporating a pendulum-support of the front wheel-belt pulley characterized in that it is made in segments and is easily foldable, which significantly reduces the length of the wheelchair when the caterpillar assembly is out of function, thus making the wheelchair suitable for indoor movement.

4. The wheelchair for stairs and obstacles, incorporating pendulum-support of the front wheel-belt pulley characterized in that it can rotate around the axis of the drive wheel to maintain the tension of the indented belts (strips) and that by changing the angle of inclination relative to the wheelchair base (and thereby to the seat with backrest) enables the wheelchair to move up and down stairs, cross over depressions, curbs and thresholds moving forward.

5. The wheelchair for stairs and obstacles, incorporating a legrest characterized in that it carries a roll-fitted overhang and a slot on which it glides upwards when the roll is met by the pendulum-support of the front wheel-belt pulley during a change of inclination while stair-climbing, in order to prevent the legrest from contacting the stair rims and to enable it to return to its starting position with the lowering of the pendulum.

6. The wheelchair for stairs and obstacles, incorporating front caster wheels characterized in that they can be lifted by an electric elevator at an obstacle, thus enabling them to cross over the obstacle or move upstairs, and then descend, thus restoring the wheelchair's capacity to move on a flat surface without using the caterpillar drive.

7. The wheelchair for stairs and obstacles, incorporating a seat with backrest characterized in that while climbing stairs it can be shifted forward by the shifting mechanism in order to neutralize the change of the total man-wheelchair centre of gravity; a change in the centre of gravity may cause the overturn of the wheelchair without a long enough caterpillar drive. This eliminates a need for a long caterpillar drive and reduces the size of the wheelchair, thus making it suitable for indoor use.

8. The wheelchair for stairs and obstacles, incorporating a power supply assembly characterized in that it consists of an internal combustion motor to serve as a battery charger, and a battery, which lends the wheelchair a characteristic of a vehicle capable of unlimited movement, independent of the main power supply, and which, among other things, enables the occupant to make outings in the open air. This feature is not used inside the building or inside the living premises, because for that purpose the battery rechargeable from the main power supply can be used.
